(19) United States
(12) Patent Application Publication
(10) Pub. No.: US 2007/0081739 A1
(43) Pub. Date: Apr. 12, 2007

(54) MODIFYING TEXT OR IMAGES WHEN DEFECT PIXELS ARE FOUND ON A DISPLAY

(75) Inventors: Tijs I. Wilbrink, En Leiden (NL); Edward E. Kelley, Wappingers Falls, NY (US)

Correspondence Address: LAW OFFICE OF DELIO & PETERSON, LLC., 121 WHITNEY AVENUE, NEW HAVEN, CT, 06510, US

(73) Assignee: INTERNATIONAL BUSINESS MACHINES CORPORATION, Armonk, NY (US)

(21) Appl. No.: 11/163,227

(22) Filed: Oct. 11, 2005

(51) Int. Cl. G06K 9/40

(52) U.S. Cl. 382/275

(57) ABSTRACT

A method of modifying text or images on a display having defective pixels, in order to make the text or images more legible. The image or text is shifted away from nonfunctioning pixels, moving the picture to a suite of pixels that are functioning. Second, the image or text is resized to prevent the nonfunctioning pixels from interfering with the readability of the displayed picture. Resizing the image or text effectively enlarges or miniaturizes the display on an array of functioning pixels. Third, the system is programmed to select different wording or a different picture having the same meaning or effect as the original display. The selected replacement picture display is formatted and shifted to accommodate an array of functioning pixels, or at least more functioning pixels than the original display.

### BACKGROUND OF THE INVENTION

1. Field of the Invention

The present invention relates to image processing, and particularly to a pixel defect correction method. More particularly, the present invention relates to a method of modifying text or images on a display having defective or nonfunctioning pixels in order to make the text or images more legible.

2. Description of Related Art

Computerized display screens use pixels to build an image. The word “pixel” is an industry-accepted abbreviation for the phrase “Picture Element”. A pixel is a single point in a graphic image. Graphics monitors display pictures by dividing the display screen into thousands (or millions) of pixels, arranged in rows and columns. The pixels are so close together that they appear connected. The number of bits used to represent each pixel determines how many colors or shades of gray can be displayed. For example, in 8-bit color mode, the color monitor uses 8 bits for each pixel, making it possible to display 2 to the 8th power (256) different colors or shades of gray. On color monitors, each pixel is actually composed of three dots—a red, a blue, and a green one. Ideally, the three dots should all converge at the same point, but all monitors have some convergence error that can make color pixels appear fuzzy.

The quality of a display system largely depends on its resolution, the number of pixels it can display, and the number of bits used to represent each pixel. Unfortunately, pixels are not impervious to failure. They will break down, usually far before the lifetime of the screen itself has been reached. Replacing a screen is very costly, not just in its hardware but also in replacement services. Moreover, having nonfunctional pixels on a screen may result in ‘broken’ images and/or text that may be more difficult to understand, illegible, or form partial, indecipherable word segments.

Usage of pixel intensive computer screens is widespread. For instance, road traffic signs and information boards use computer screens. Having nonfunctioning pixels on these screens might result in warnings signs or safety statements being illegible, or simply misunderstood, especially when the users have only a very limited period of time in which to read the text or view the image, such as the case when trying to read a highway sign from a moving vehicle.

In U.S. patent application Publication No. US2005/0058362 filed by Kita on Sep. 17, 2004, entitled “IMAGE PROCESSING APPARATUS, IMAGE PROCESSING METHOD AND PROGRAM,” a defective portion of an image composing a plurality of pixels is corrected by selecting target pixels from normal pixels. Any defective pixel is detected within a predetermined area extending about each selected first target pixel as its center. A normal pixel present on an extension line connecting the first target pixel and the defective pixel is then detected and set as a second target pixel. For each defective pixel present between the first and second target pixels, an interpolation value is calculated along with a weight coefficient. The weighted average value of the interpolation values for each defective pixel is used for the correction of the defective pixels. This algorithm, however, may not necessarily make an illegible image more legible, and may be inadequate for screen signs with a limited number of pixels, such as traffic signs and other signs in public thoroughfares.

In U.S. Pat. No. 6,751,005 issued to Barnick, et al., on Jun. 15, 2004, entitled “COMPENSATING FOR PIXEL DEFECTS BY SPATIAL TRANSLATION OF SCENE CONTENT,” pixel defects are compensated by an imaging apparatus. An image is formed at a first position. An actuator then shifts a spatial light modulator over the shift distance to a second position. A second image is formed on the spatial light modulator shifted by the shift distance, and directed to the surface. In Barnick, the loss of the defective pixel is addressed through the reflection of the light of a surrounding pixel towards the defective one. This represents a hardware solution, which has cost disadvantages and lacks the upgrade capability of a software solution.

In addition, it is appreciated that in traffic signs, a non-displaying pixel is not always caused by a hardware malfunction. It is possible that dirt is covering part of the sign. In the prior art, none of the solutions integrate the detection or resolution of when the sign has accumulated dirt that would affect the sign's display.

Consequently, there is a need in the art for detecting nonfunctioning pixels and providing a software method capable of manipulating a graphical image or text with defective pixels in order to make the image or text legible and prevent incorrect readings caused by the non-displaying pixels within the screen.

### SUMMARY OF THE INVENTION

Bearing in mind the problems and deficiencies of the prior art, it is therefore an object of the present invention to provide a pixel defect correction method.

It is another object of the present invention to provide a method of modifying images and text for display on screens having defective pixels.

A further object of the invention is to provide a method of providing alternative text and images to screens having nonfunctioning pixels that interrupt the message.

It is yet another object of the present invention to provide a method of changing a screen images to be consistent with other screens in close proximity when defective, nonfunctioning pixels are present.

Still other objects and advantages of the invention will in part be obvious and will in part be apparent from the specification.

The above and other objects, which will be apparent to those skilled in art, are achieved in the present invention which is directed to a method of modifying an image on a screen having nonfunctioning pixels, the method comprising: detecting non-displaying pixels on the screen; downloading screen information into a processing system when non-displaying pixels are detected; implementing a hardware solution or implementing a software solution, when the hardware solution is not available, the software solution comprising: locating defective pixels on the screen; determining if the defective pixels disrupt the image; and altering the image on the screen such that the image uses fewer defective pixels. Detecting the non-displaying pixels includes identifying pixels that no longer accept electrical power, measuring voltage and current levels of pixels, detecting optical pixel performance, measuring continuity of pixel circuitry, or performing a visual check. The method also includes storing each location of the defective pixels, and analyzing the location with respect to the image to determine the amount of the defective pixels in the image. The step of altering the image includes shifting the image on the screen, resizing the image, moving the image, or providing an alternate image. The processing system may be an online system, a centralized system, or an embedded processor within the screen. The step of determining if the defective pixels disrupt the image includes determining a ratio of defective pixels to non-defective pixels of the image and comparing the ratio to a predetermined acceptable level of illuminated pixels, or having an operator manually determine if the image is acceptable with the defective pixels therein. The step of shifting the image on the screen includes moving the image to a location on the screen that uses less of the defective pixels. The step of resizing the image includes reformatting the image size or providing a different font for the image utilizing a different pixel subset. The step of moving the image includes performing a partial scroll of the image on the screen, which moves the image off a number of the defective pixels for at least a period of time or permanently. The step of providing an alternate image includes downloading information from a second database comprising alternative images, and selecting an appropriate alternate image that is consistent with nearby positioned signs.

In a second aspect, the present invention is directed to a method of modifying an image on a screen having nonfunctioning pixels, the method comprising: detecting non-displaying pixels on the screen; downloading screen information into a processing system when non-displaying pixels are detected; implementing a hardware solution or implementing a software solution, when the hardware solution is not available, the software solution comprising: locating defective pixels on the screen; determining if the defective pixels disrupt the image; and altering the image on the screen such that the image uses fewer defective pixels, including shifting the image on the screen, resizing the image, moving the image, providing an alternate image, or any combination thereof. The step of providing an alternate image includes: determining if other screens are at nearby locations displaying the image or conveying a same message as the image; selecting the alternate image from a database of alternate images; and altering images on the other screens to be consistent with the alternate image text, font, and size.

In a third aspect, the present invention is directed to a program storage device readable by a machine, tangibly embodying a program of instructions executable by the machine to perform method steps for modifying an image on a screen having nonfunctioning pixels, the method steps comprising: detecting non-displaying pixels on the screen; downloading screen information into a processing system when non-displaying pixels are detected; implementing a hardware solution or implementing a software solution, when the hardware solution is not available, the software solution comprising: locating defective pixels on the screen; determining if the defective pixels disrupt the image; and altering the image on the screen such that the image uses fewer defective pixels.

### BRIEF DESCRIPTION OF THE DRAWINGS

The features of the invention believed to be novel and the elements characteristic of the invention are set forth with particularity in the appended claims. The figures are for illustration purposes only and are not drawn to scale. The invention itself, however, both as to organization and method of operation, may best be understood by reference to the detailed description which follows taken in conjunction with the accompanying drawings in which:

FIG. 1 depicts a flow chart of the methodology of the present invention for the detection of pixel failure and the selection of repair processes for traffic signs.

FIG. 2 depicts a flow chart of sub process 1, which employs each of the corrective actions that may be taken by the present invention to mitigate a disrupted image due to nonfunctioning pixels.

FIG. 3 is a flow chart detailing the process flow for employing an alternative text or image to a sign having defective, nonfunctioning pixels, and aligning the altered sign with nearby signs.

### DESCRIPTION OF THE PREFERRED EMBODIMENTS

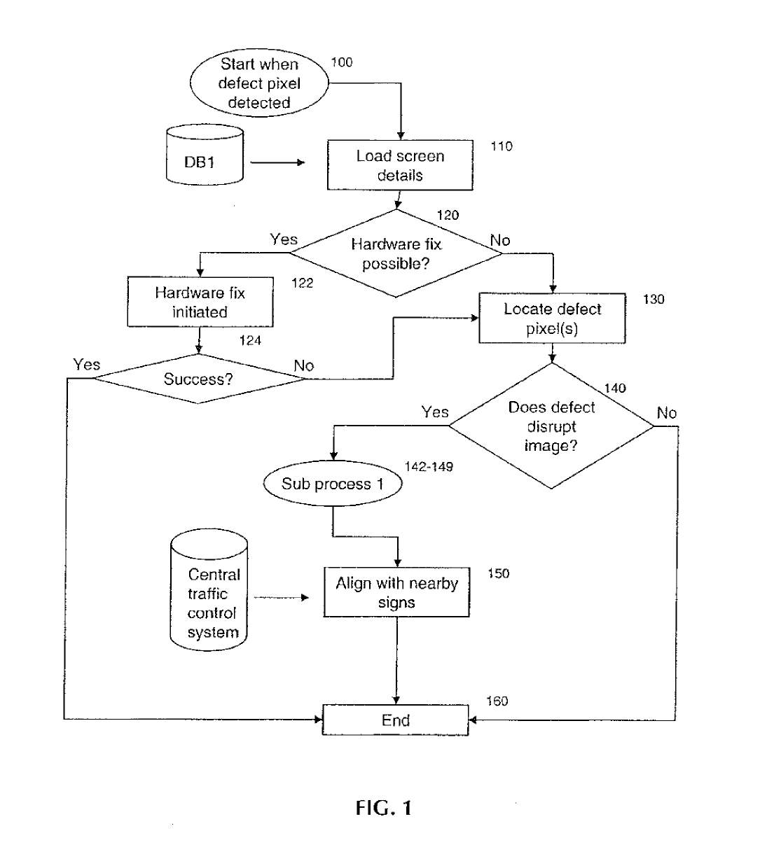

In describing the preferred embodiment of the present invention, reference will be made herein to FIGS. 1-3 of the drawings in which like numerals refer to like features of the invention.

The present invention proposes to manipulate the image or text to be displayed on a screen in order to show this image or text without having to use nonfunctioning pixels, or at least minimizing the use of nonfunctioning pixels, resulting in more legible information.

Three separate embodiments are developed. Each of these embodiments may be used individually or in combination with the other. In the first embodiment, the position of the image or text is altered. This effectively moves the image or text to a suite of pixels that are functioning, and off the pixels that are nonfunctioning. To the extent that it is not possible to move completely the image or text off nonfunctioning pixels, the image or text may at least be shifted to a position that allows for fewer nonfunctioning pixels for display. In a second embodiment, the image or text is resized to prevent the nonfunctioning pixels from interfering with the readability of the displayed picture. Through resizing, the image or text is effectively enlarged or miniaturized for display on an array of functioning pixels. Again, to the extent that it is not possible to resize completely the image or text away from nonfunctioning pixels, at least the image or text is resized to allow for fewer nonfunctioning pixels in the altered display. In a third embodiment, the system is programmed to select different wording or a different picture having the same meaning or effect as the original display. Preferably, the selected replacement picture display is formatted and shifted to accommodate an array of functioning pixels, or at least more functioning pixels than the original display. Resizing is preferably employed to reduce or enlarge the image size by approximately 10 to 40 percent, more preferably, resizing is held to a 20 percent increase or decrease of the original image size.

Before any of the three above-identified techniques may be employed, certain necessary information must be acquired and analyzed. This information must be gathered from the operable systems where the information is to be ultimately displayed. The gathered information includes format and state-of-the-screen data, and the identification of the location of nonfunctioning pixels. One method of determining which pixels are nonfunctioning pixels is to identify the pixels that no longer accept electrical power. Other methods may be used, such as voltage or current measurements, optical detectors, or continuity measurements, to name a few. Additionally, a visual check may uncover pixels that are functioning but nevertheless are obscured from view by an accumulation of dirt or debris on the sign's surface. Independent of how the nonfunctioning pixels are detected, it is necessary to store the location of the nonfunctioning pixels, and analyze their location with respect to the location of the text or image on display. Knowing the format and other state-of-the-screen data, it is then possible to determine the amount of shift, resizing, or type of alternate display needed to eliminate a display that incorporates an unacceptable level of nonfunctioning pixels.

Optionally, this system allows for use based on manual input. For example, highway maintenance personnel may manually provide information to the system regarding the location of nonfunctioning or obscured pixels on operating road signs so that any or all of the three embodiments may be effectively employed.

All of the above-identified options employ the present invention's pixel detection procedure to locate and evaluate nonfunctioning pixels in the various display formats. Importantly, the nonfunctioning pixels are addressed in a way that they will not result in a difficult to understand presentation of text or images. In this manner, the user is able to provide input on the precise level of deviation in displayed picture that is acceptable. The user may also select an option which may be prompted with new alternative displays that do not result in illegible instruction or information.

Alternatively ‘black’ image areas may be used to smartly position the image on a screen having nonfunctioning pixels.

FIG. 1 depicts the methodology of the present invention for the detection of pixel failure and the selection of repair processes for traffic signs. It should be noted, however, that the present invention may be employed for any pixel-based sign, such as public thoroughfare signs, and is by no means limited to traffic signs. The application of the present invention to traffic signs is provided for exemplary purposes.

The methodology begins with employing a system for detecting non-displaying pixels, step 100. This detection may be performed through hardware, by such techniques as electrical monitoring of the throughput power to the pixel, optical evaluation, and the like, or by manual means from an operator viewing the traffic sign. The system resides either online or on a centralized system, such as a traffic control center, and the like. Alternatively, the system may be embedded in a processor within the sign itself, or within a computer controlling the traffic signs on location. The screen details are then downloaded into a processing system, step 110, from a first database, DB1. These details include the screen size in pixels, and information concerning the ability to fix the pixels through hardware solutions. At this juncture, it is determined if a hardware fix is possible, step 120. Such remedies include reflecting the light of a nearby pixel to accommodate the loss of light of the adjacent, nonfunctional pixel. If a hardware fix is indeed feasible, it is desirable to initiate this fix first, step 122. If the hardware fix is successful, meaning the sign is corrected and legible, the repair process ceases. If, however, the attempted hardware fix is not successful, the software solution of the present invention is initiated. In a similar manner, if a hardware solution is not possible, the software solution is automatically initiated, step 124.

If a software solution is required, the defective, nonfunctioning pixels are located, step 130. The pixels may be detected by analyzing electricity flowing through the LEDs and crystals. A logic branch is considered as to whether the defects disrupt the image, step 140. If the defects do not disrupt the image, there is no need to implement a software correction, and the method ends. This determination is made either automatically or manually. In the automatic embodiment, the defective, nonfunctioning pixels in the text or image are taken as a percentage of those that were originally to illuminate. The acceptable percentage of illuminated pixels is predetermined, and optionally includes different values for different signs or different messages on a given sign. For example, a speed limit sign may have more tolerance for nonfunctioning pixels than a sign indicating an open bridge. The amount of non-functioning pixels that a particular message may tolerate for a given sign type is predetermined and may be inputted into the system's processor for an automatic determination. In the manual embodiment, the operator or owner decides for each occurrence if a repair should be made. For this scenario, the system displays the representation of the illuminated sign with defective pixels on a remote user's screen.

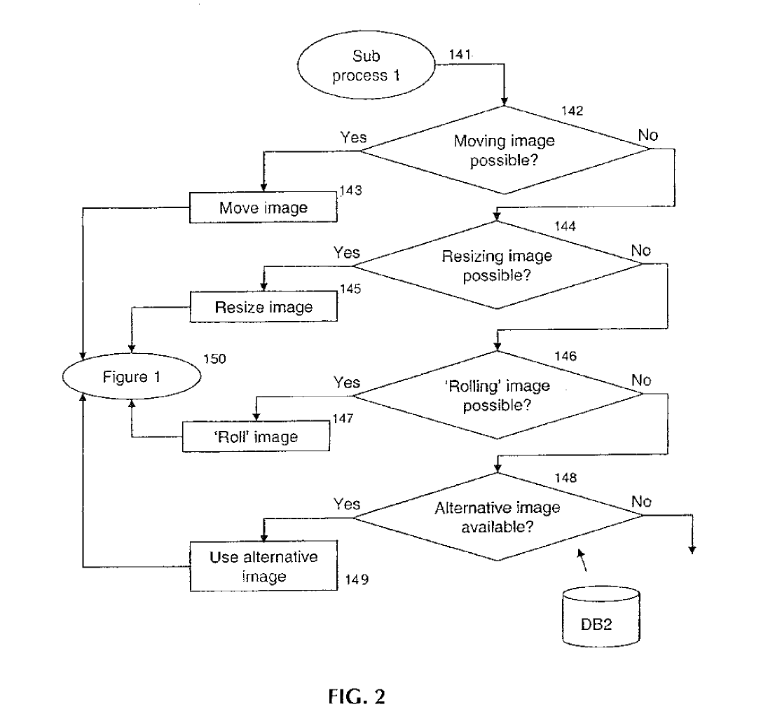

If the image is disrupted by defective pixels, any one or all of the corrective processes of the present invention may be employed. FIG. 2 depicts sub process 1, which sequentially employs each of the corrective actions that may be taken by the present invention to mitigate a disrupted image due to nonfunctioning pixels.

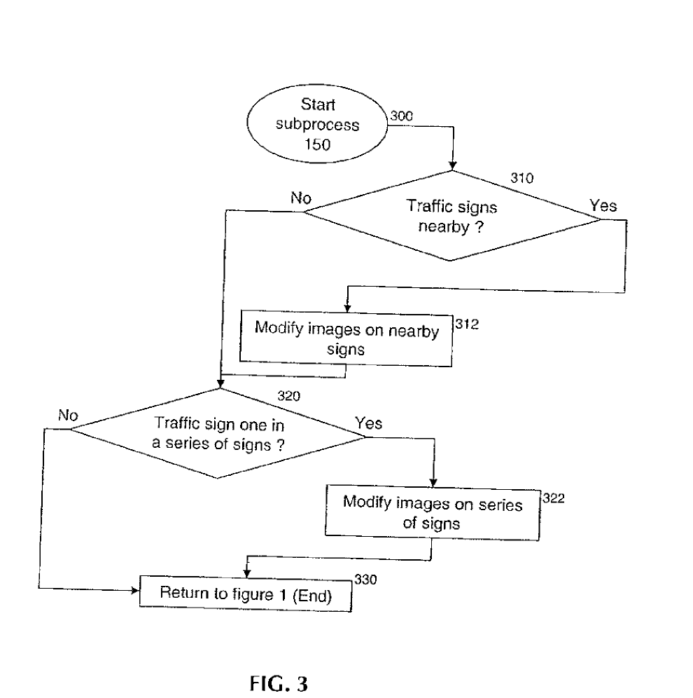

In performing sub process 1, a first evaluation considers whether it is possible to move or shift the image to a location on the sign that utilizes fewer defective pixels while making the image more legible, step 142. This determination includes taking into account the screen size, the outside and inside sign area that is unused by the text or image, and where the defective, nonfunctioning pixels are located and grouped. If a shift or move is feasible, it is performed, step 143. The shift is preferably in the direction where the least movement will eliminate the use of the largest number of defective pixels to make the repair appear as unapparent as possible to the reader. It is possible to shift the text or image to a location where defective, nonfunctional pixels are still present, provided that those pixels do not hinder the interpretation of the text or image. If a shift or move does not remedy the situation, the next evaluation considers whether the image could be resized to utilize fewer defective pixels while again still being legible, step 144. The resizing effort may include reformatting the image size or providing for a new font that utilizes a different pixel subset. Preferably, resizing the image or text is limited to ±20% of the original image or text size. If resizing remedies the situation, it is performed, step 145. Otherwise, a third evaluation is considered. The third evaluation involves moving the text or image, such as rolling the image up/down or side-to-side, step 146. This partial scroll of the image effectively moves the image off the nonfunctioning pixels at least for a period of time or permanently. If the rolling of the image is deemed successful, it is employed, step 147. In the event none of the evaluations are successful in making the image more legible, a fourth alternative is considered which effectively replaces the image with an alternative image, step 148. In order to determine which replacement image to use, a second database, DB2, is consulted. The appropriate alternative image is then employed, step 149. The appropriate alternative image is aligned with nearby positioned signs to ensure consistency in both meaning and image positioning for the sign, step 150 (FIG. 1). FIG. 3, described in detail below, delineates the process flow for aligning the altered text or image with nearby signs. Once aligned, the process is then completed, step 160.

Although FIG. 2 depicts a sequential operation of evaluations of an image with defective, nonfunctional pixels, it should be noted that a parallel operation may also be employed, whereby each evaluation may be made in combination with any other evaluation, so that two or more evaluations are used to adjust the image away from defective pixels. The present invention is not limited to using only one evaluation technique at a time.

FIG. 3 is a flow chart detailing the process flow for employing an alternative text or image to a sign having defective, nonfunctioning pixels, and aligning the altered sign with nearby signs. The alignment process is triggered by step 150 of FIG. 1, shown as step 300 in FIG. 3. To continue the exemplary example of altering a traffic sign, a central online system determines if there are traffic signs at the same road location, or on the same side of the road, displaying the same text or image, step 310. This information is stored in the road-governing systems, such as a database in the traffic control center. If nearby traffic signs are present, the text or images on these signs are modified similar to the originally affected traffic sign, step 312. The system then checks if the traffic sign is one in a series of signs that display similar messages, step 320. This check is also performed even if there are no traffic signs nearby. If there are signs nearby, consistency in the text or image of each sign is maintained with respect to the text, font, position, and the like, as these signs are altered accordingly, step 322. Note that the altered signs may also have defects as well, which may result in conflicts that will require resolution by the process of FIG. 1. If no common workable alternative can be found, the series of signs are set at different sizes and positions, but not with different images. If no feasible fix or alternative can be selected, the original sign will turn off when the sign is a follow-on sign in a series of the same image. Whether the original sign is not one of a series of traffic signs, or if the series of traffic signs has indeed been altered, this sub process reverts back to the original process flow, step 330.

While the present invention has been particularly described, in conjunction with a specific preferred embodiment, it is evident that many alternatives, modifications and variations will be apparent to those skilled in the art in light of the foregoing description. It is therefore contemplated that the appended claims will embrace any such alternatives, modifications and variations as falling within the true scope and spirit of the present invention.

What is claimed is:

1. A method of modifying an image on a screen having nonfunctioning pixels, said method comprising:
detecting non-displaying pixels on said screen;
downloading screen information into a processing system when non-displaying pixels are detected;
implementing a hardware solution or implementing a software solution, when said hardware solution is not available, said software solution comprising:
locating defective pixels on said screen;
determining if said defective pixels disrupt said image; and
altering said image on said screen such that said image uses fewer defective pixels.

2. The method of claim 1 wherein detecting said non-displaying pixels includes identifying pixels that no longer accept electrical power, measuring voltage and current levels of pixels, detecting optical pixel performance, measuring continuity of pixel circuitry, or performing a visual check.

3. The method of claim 1 including storing each location of said defective pixels, and analyzing said location with respect to said image to determine the amount of said defective pixels in said image.

4. The method of claim 1 wherein said step of altering said image includes shifting said image on said screen, resizing said image, moving said image, or providing an alternate image.

5. The method of claim 1 wherein said processing system includes an online system, a centralized system, or an embedded processor within said screen.

6. The method of claim 1 wherein said step of downloading screen information includes downloading from a first database.

7. The method of claim 1 wherein said screen information includes pixel size, pixel electrical parameters, and pixel optical parameters.

8. The method of claim 1 wherein said step of determining if said defective pixels disrupt said image includes determining a ratio of defective pixels to non-defective pixels of said image and comparing said ratio to a predetermined acceptable level of illuminated pixels, or having an operator manually determine if said image is acceptable with said defective pixels therein.

9. The method of claim 8 wherein said predetermined acceptable level of illuminated pixels includes different values for different screens or different images on a screen.

10. The method of claim 4, wherein said step of shifting said image on said screen includes moving said image to a location on said screen that uses less of said defective pixels.

11. The method of claim 10 further including moving said image in a direction where the least movement will eliminate the use of the largest number of said defective pixels.

12. The method of claim 4, wherein said step of resizing said image includes reformatting said image size or providing a different font for said image utilizing a different pixel subset.

13. The method of claim 12 wherein said reformatting includes resizing said image to enlarge or decrease said image original size by approximately 10 to 40 percent.

14. The method of claim 4, wherein said step of moving said image includes performing a partial scroll of said image on said screen, which moves said image off a number of said defective pixels for at least a period of time or permanently.

15. The method of claim 4, wherein said step of providing an alternate image includes downloading information from a second database comprising alternative images, and selecting an appropriate alternate image that is consistent with nearby positioned signs.

16. A method of modifying an image on a screen having nonfunctioning pixels, said method comprising:
detecting non-displaying pixels on said screen;
downloading screen information into a processing system when non-displaying pixels are detected;
implementing a hardware solution or implementing a software solution, when said hardware solution is not available, said software solution comprising:
locating defective pixels on said screen;
determining if said defective pixels disrupt said image; and
altering said image on said screen such that said image uses fewer defective pixels, including shifting said image on said screen, resizing said image, moving said image, providing an alternate image, or any combination thereof.

17. The method of claim 16 wherein said step of providing an alternate image includes:
determining if other screens are at nearby locations displaying said image or conveying a same message as said image;
selecting said alternate image from a database of alternate images; and
altering images on said other screens to be consistent with said alternate image text, font, and size.

18. The method of claim 16 wherein said step of determining if said defective pixels disrupt said image includes determining a ratio of defective pixels to non-defective pixels of said image and comparing said ratio to a predetermined acceptable level of illuminated pixels, or having an operator manually determine if said image is acceptable with said defective pixels therein.

19. A program storage device readable by a machine, tangibly embodying a program of instructions executable by the machine to perform method steps for modifying an image on a screen having nonfunctioning pixels, said method steps comprising:
detecting non-displaying pixels on said screen;
downloading screen information into a processing system when non-displaying pixels are detected;
implementing a hardware solution or implementing a software solution, when said hardware solution is not available, said software solution comprising:
locating defective pixels on said screen;
determining if said defective pixels disrupt said image; and
altering said image on said screen such that said image uses fewer defective pixels.

20. The program storage device of claim 19 wherein said step of altering said image on said screen such that said image uses fewer defective pixels includes shifting said image on said screen, resizing said image, moving said image, providing an alternate image, or any combination thereof.
